(19) United States
(12) Patent Application Publication
(10) Pub. No.: US 2026/0316252 A1
(43) Pub. Date: Oct. 15, 2026

(54) Carbon Fiber Wrench

(71) Applicant: LeRoy Paul Jaurigui, Hanford, CA (US)

(72) Inventor: LeRoy Paul Jaurigui, Hanford, CA (US)

(21) Appl. No.: 19/177,596

(22) Filed: Apr. 13, 2025

(51) Int. Cl. B25G 1/10

(52) U.S. Cl. CPC B25G 1/105

(57) ABSTRACT

The Carbon Fiber Pump Lid Wrench is used by the Pool Technician and Pool Home Owners to remove certain pump tank lids. Specifically, Hayward Super II Pumps and Sta-Rite Dura-Glas II and Maxi Glas II Trap Lid-Also S lids and Sta-Rite, American Products, Swim-Quip and Hayward strainer lids. The Carbon Fiber Wrench is made of 3K Carbon Fiber with a Twill Matte finish. The Carbon Fiber Wrench is lighter than steel and is five times stronger than steel and twice as stiff, when considering their strength to weight ratio. The Carbon Fiber Pump Lid Wrench is the ideal tool used by the Pool Technician and the homeowner. Due to its Carbon Fiber Material, the strength of the material, the light weight of the material—which makes it easy to carry around and the fact that Carbon Fiber is a no rust material.

### FIELD

The present invention is a Carbon Fiber Wrench (Multi-Lid Wrench) that is used to remove pump tank lids from pump tanks that are attached to motors used to filter water for swimming pools.

### BACKGROUND OF THE INVENTION

This carbon fiber pump tank lid wrench (Multi-Lid Wrench) will remove certain types of pump tank lids. As pressure builds within the pump tank, the lid tightens and it becomes very difficult to remove the pump tank lid. The carbon fiber wrench is used to remove the pump tank lid from the pump tank. Pool Technicians and Swimming pool owners will use the Carbon Fiber Wrench to remove the pump tank lid to remove the debris from the pump tank basket.

### BRIEF SUMMARY OF THE INVENTION

1.) This Summary is to give a brief description of the invention and not limits the scope of the invention. The Carbon Fiber Wrench (Multi-Lid Wrench) is used to remove the pump tank lid from the pump tank in order to empty the pump tank basket. The Carbon Fiber Wrench is strong due to its layers of carbon fiber and the handle is long enough to provide extra leverage to remove tight pump tank lids. The handle itself can also be used to remove certain types of pump tank lids. The Carbon Fiber Wrench is needed to remove the pump tank lid and remove the debris from the pump tank basket. Debris gets in the pool as the water circulates in the pool and the debris is moved to the pump tank basket. The Carbon Fiber Wrench will remove the pump tank lid in order to get to the pump tank basket to remove the debris. The Carbon Fiber Wrench is needed in the pool industry-because of its strength and the long handle that gives extra leverage to remove tight pump tank lids-also, the handle can be used to remove pump tank lids as well.

### DETAILED DESCRIPTION OF THE INVENTION

2.) The following description references to the above drawings of the invention. The description is not to be taken in a limiting sense, but is made merely for the purpose of illustrating the vast improvement of what is currently in the Pool Industry. The invention drawing primarily provides the Pool Technician and the Homeowner a better understanding on how much easier and faster the invention will accomplish the task at hand.

### 3.) BRIEF DESCRIPTION OF THE SEVERAL VIEWS OF THE DRAWING(S)

FIG. 1 shows In the following detailed portion of the present description. The teachings of the present application will be explained in more detail with reference to the example embodiments shown in the drawings, in which:

FIG. 1 is an isometric view of a device according to a first embodiment.

FIG. 2 is an isometric view of a device according to a second embodiment

FIG. 3 is an isometric view of a device according to a third embodiment, and

FIG. 4 is an isometric view of a device according to a fourth embodiment.

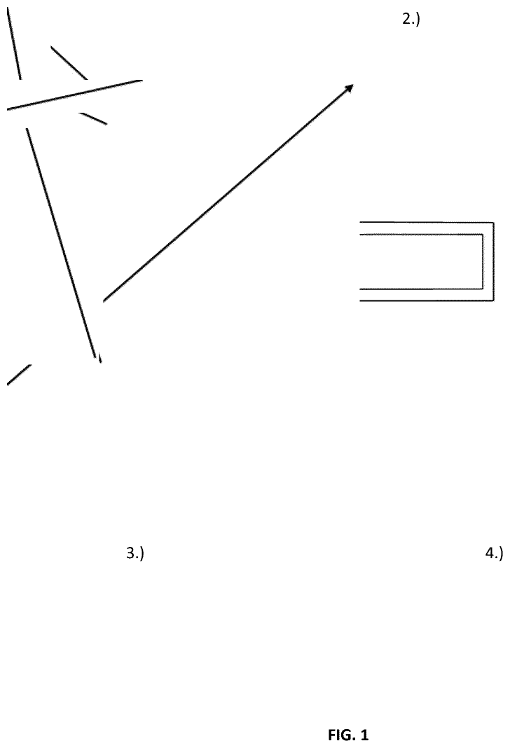

1.) Referring to FIG. 1—shows the invention that is the Carbon Fiber Wrench in its entirety. The Carbon Fiber Wrench is made of 3K Carbon Fiber with a twill matte finish and 7 mm in thickness. Carbon fiber is known for its high tensile strength, which means it can withstand significant pulling force and significant pounds of side load. Carbon fiber is lighter than steel but just as strong, making it a popular choice for applications where weight reduction is crucial. 1.) Length of handle is 9 inches. 2.) Wrench is 8 inches in length-which equals total length is 17 inches. 3.) the width of the inside of the wrench is 2.55 inches. 4.) Inside of wrench length is 7 inches length.

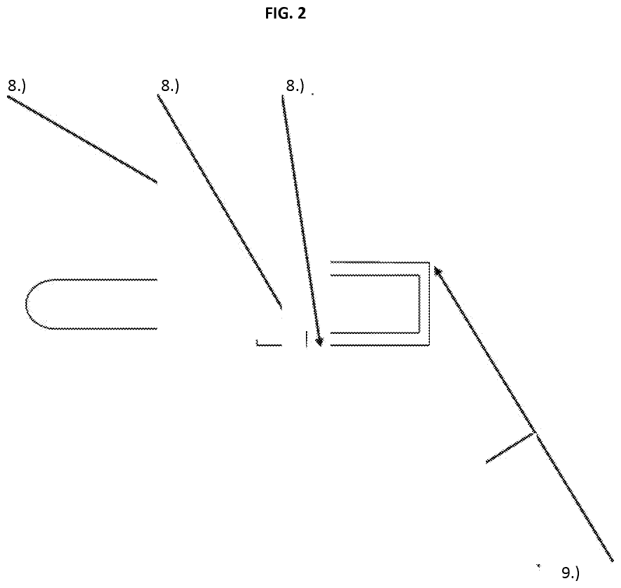

Referring to FIG. 2-5.) the handle has been chamfered-which gives the handle a smoother finish and easier to apply pressure with your hand. 6.) Width of the handle is 2 inches. 7.) Width of the top of wrench is 0.25 inches-by length

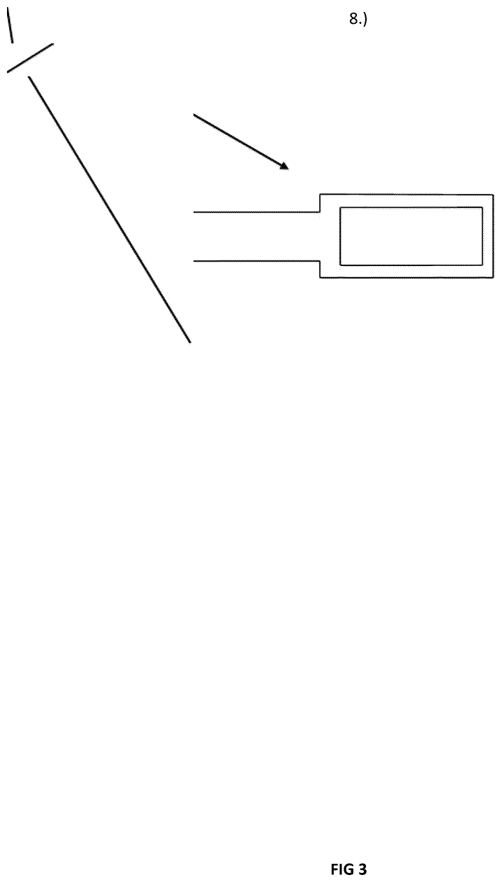

Referring to FIG. 3-8.) Width of the sides of the wrench are 8.84 mm. 9.) Width of the top of the wrench is 3.25 inches.

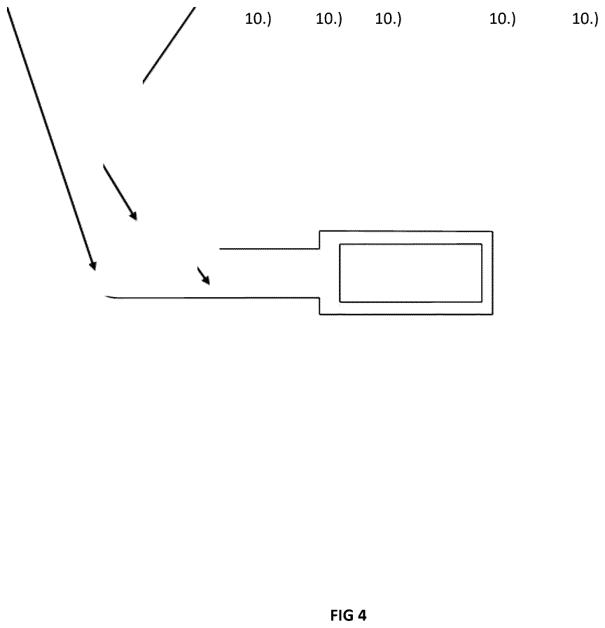

Referring to FIG. 4-10.) The corners of the wrench have been rounded—R2 rounding—slight rounding.

### 4.) DETAILED DESCRIPTION OF THE INVENTION

The following Description references the above drawing. It is recognizable to those skilled in the art of Pool Service Technician. As shown in FIG. 1—The claimed invention is a Carbon Fiber Wrench (Multi-Lid Wrench) for the Pool Industry and it is used to open certain types of pool pump tank lids. Specifically, Hayward Super II Pumps and Sta-Rite Dura-Glas II and Maxi Glas II Trap Lid—Also S lids and Sta-Rite, American Products, Swim-Quip and Hayward strainer lids. What makes this invention unique is the material that the wrench is made from. It is made of 3K Carbon Fiber with a twill matte finish, which means it is five times stronger than steel and twice as stiff, when considering their strength to weight ratio—Carbon Fiber is also lighter than steel. This gives the pool Technician and the homeowner a strong and durable tool that is light and the pool technician can carry the carbon fiber wrench in the Pool Technician Caddy without the extra weight of most metal or steel tools. The 3k Carbon Fiber wrench with twill matte finish has the strength but yet light enough to carry around all day is designed for the pool technician and the pool owner to open tight pump tank lids.

1. A Carbon Fiber Wrench having a handle connected to a wrench that is used in the Pool Industry to remove pool tank pump lids to empty the pump tank basket of debris.
